(19) United States
(12) Patent Application Publication
(10) Pub. No.: US 2004/0105657 A1
(43) Pub. Date: Jun. 3, 2004

(54) Method and apparatus for processing digital images files to a transportable storage medium

(76) Inventor: Afzal Hossain, San Jose, CA (US)

Correspondence Address: David Giglio, Esq., 231 Elizabeth St., Utica, NY, 13501, US

(21) Appl. No.: 10/307,543

(22) Filed: Dec. 2, 2002

(51) Int. Cl. H04N 5/76; G11B 27/00

(52) U.S. Cl. 386/52; 386/131

(57) ABSTRACT

There is provided a method and apparatus for transferring digital image files to a storage medium. The files in the storage medium are interactively played on either a personal computer or a standard television. The digital image files are representative typically of a photo album. The user has control of manipulating and sequencing the digital photos. During playback, the user has control of sequence during playback on either the personal computer or the television. A custom software package allows for the controlled playback of the digital photos with most standard playback devices.

This application is related to a pending application by the same inventor, Ser. No. 09/961,893 that was filed on or about Sep. 24, 2001, which is hereby incorporated by reference.

### FIELD OF THE INVENTION

The present invention relates to the field of still pictures and, more particularly to a method and apparatus for transferring still picture digital image files to a transportable storage medium.

### BACKGROUND OF THE INVENTION

It is known to digitally scan still pictures into digital image files that can be stored into memory. It is also known to create digital image files using a digital camera, wherein the digital image files are stored on a memory card. Other types of storing digital image files is also known. It is also known to process these stored image files and transfer the processed files to a second storage medium. Many companies offer transfer of stored image files to a compact disc. The compact disc is later interfaced with a personal computer so that the images can be viewed, manipulated and even e-mailed.

It is also known to process these stored image files to a compact disc so that the stored image files can be interfaced with a special purpose digital video disc player for viewing with a television. However, there are many limitations to these methods and discs. First, these discs inevitably require the user to purchase a preselected digital video disc player. The discs will not operate with most standard digital video players.

Another drawback is that the user has no control over the playback of the images. The images will not stay on the television indefinitely nor is there a universal method of controlling forward and reverse when viewing a sequence of images. Generally, it is a hit and miss proposition to forward and reverse control the sequence of images.

Still yet another drawback is that the images often do not use the entire picture space on the television screen. Therefore, the images are more difficult to view and enjoy.

### SUMMARY AND OBJECTS OF THE PRESENT INVENTION

It is therefore an object of the present invention to improve the art of photography.

It is another object of the present invention to improve the art of viewing still pictures.

It is still yet another object of the present invention to improve the art of storing digital image files onto digital video discs.

It is a further object of the present invention to improve the art of digital image processing.

It is a feature of the present invention to provide an acknowledgment or advertising information on a digital video disc that will appear to a user during playback.

It is another feature of the present invention to provide a parallel processing system for simultaneously digitally processing image files to a plurality of digital video discs.

It is yet another feature of the present invention to provide a second storage medium that is easily interfaced with a standard storage medium playback device.

It is still another feature of the present invention to provide a second storage medium that is easily interfaced with a standard storage medium playback device and a personal computer.

It is still yet another feature of the present invention to provide a digital video disc that is compatible for playback with most standard digital video disc players, wherein the displayed images are controllable for duration and sequence.

It is a further feature of the present invention to provide a digital video disc that is compatible for playback with most standard digital video disc players, wherein the displayed images utilize substantially the entire pixel space on the television.

These and other objects are provided in accordance with the present invention in which there is provided an apparatus for converting digital image files stored on a first storage medium to a second storage medium, wherein the digital image files on the first storage medium includes digital image files representative of a plurality of images. A first interface interfaces the first storage medium with a computer software system. A second interface interfaces the second storage medium to the computer software system.

The computer software system includes memory for storing the digital image files from the first storage medium. A first formatting software file formats the stored digital image data files to a personal computer format. A second formatting software file formats the stored digital image files to at least one digital video standard format.

The computer software system also includes writing files for writing the formatted digital image files to the second storage medium. Operational files install first operational data onto the second storage medium, such that the first operational data is interactive with a personal computer operating system. The operational files also install second operational data onto the second storage medium, such that the second operational data is interactive with a standard second storage medium player operating system.

The computer software system further includes a grouping method for grouping the digital image files into at least one subgroup. A manipulation method included in the computer software system allows the user to manipulate and alter any of the digital image files. A sequencing method allows for storing the digital image files in a chosen sequence. A selection method allows the user to choose at least one digital video standard.

A display shows the status of the conversion. Typically, the second storage medium is either a digital video disc (DVD), a compact disc or a hard disc in a digital videocassette recorder playback device. However, it is foreseeable that newer yet to be marketed types of storage medium can also work.

The first storage medium can include memory and a digital scanner capable of digitally scanning at least one still photograph. The first storage medium can also be a memory card from a digital camera. The first storage medium is not to be limited by any examples set forth herein, but should extend to all those known to one skilled in the art.

There is provided a digital video disc that can be interfaced with a personal computer and a video standard display. The digital video disc includes digital image files that are representative of at least one image, first computer software files for processing the digital image files into a format that is readable by a personal computer, and second computer software files for processing the digital image files into a video standard format that is readable by a standard digital video disc playback device which is interfaced with a video standard display. A standard video disc playback device is a video playback device that is based on a popular standard, such as DVD-Video.

The first computer software files includes a grouping method for grouping the digital image files into at least one subgroup, a display method for displaying thumbnail images of a subgroup onto a computer monitor, a selection method for selecting digital image files of at least one thumbnail image from the selected subgroup, second display method for displaying a full image representative of the selected digital image files, a manipulation method for manipulating the displayed full image, and a copying method for copying digital image files from a group of digital image files.

The second computer files includes a grouping method for grouping the image files into at least one subgroup, a selection method for selecting one of the subgroups, a display method for displaying a first image onto the video standard display, and a control method for controlling the playback, timing and sequence of the displayed images.

Preselected video streamer files allows the digital video disc to contain files that are representative of moving advertisement, acknowledgment or another moving scene.

A multiple processing system for processing and transferring digital image files from a plurality of first storage mediums to a plurality of second storage mediums is also provided. The multiple processing system includes parallel computer processing capability which generally comprises a plurality of computer processing units for processing a plurality of digital image files, a plurality of digital image inputs for inputting the plurality of digital image files, and a plurality of digital media writers for transferring the processed digital image files onto the plurality of second storage mediums. A first parallel interface delivers the digital image file inputs from the digital image inputs to the parallel computer processors. A second parallel interface delivers the processed image files to the plurality of digital media writers.

### BRIEF DESCRIPTION OF THE DRAWINGS

The above and other objects of the present invention will be better understood by reading the following detailed description of the preferred embodiments of the invention, when considered in connection with the accompanying drawings, in which:

FIG. 1 is a block diagram in accordance with a preferred embodiment of the present invention;

FIG. 2 is a perspective view of the preferred embodiment as shown in FIG. 1;

FIG. 3 is a perspective view of an alternate preferred embodiment as shown in FIG. 1;

FIG. 4 is a block diagram depicting an optional feature of the present invention;

FIG. 5 is a block diagram of an alternative embodiment of the present invention;

FIG. 6 is a block diagram of an example of a storage sequence in accordance with a preferred embodiment of the present invention;

FIG. 7 is a block diagram of an example of a reproduction sequence in accordance with a preferred embodiment of the present invention;

FIG. 8 is a block diagram of a playback sequence of the reproduction sequence of FIG. 7;

FIGS. 9a and b are block diagrams illustrating sample menu images that appear during playback;

FIG. 9c is a block diagram showing a remote control unit in accordance with a preferred playback of the present invention;

FIG. 10 is a block diagram in accordance with another alternative embodiment of the present invention;

FIG. 11 is a block diagram in accordance with a further alternative embodiment of the present invention;

FIG. 12 is a block diagram in accordance with yet a further alternative embodiment of the present invention;

FIG. 13 is a block diagram in accordance with still another preferred embodiment of the present invention;

FIG. 14 is a block diagram in accordance with yet still another embodiment of the present invention;

FIG. 15 is a block diagram in accordance with yet still a further embodiment of the present invention;

FIG. 16 is a block diagram in accordance with still yet another embodiment of the present invention;

FIG. 17 is a block diagram showing slideshow and computer image processing software system of FIG. 1;

FIG. 18 is a perspective view of a preferred embodiment of the present invention wherein there is no monitor to accompany conversion;

FIG. 19 is a perspective view of another preferred embodiment of the present invention, wherein the present invention is designed inside of a kiosk; and

FIG. 20 is a block diagram of a preferred embodiment wherein the present invention is designed inside of a photo finishing system.

### DETAILED DESCRIPTION OF A PREFERRED EMBODIMENT OF THE PRESENT INVENTION

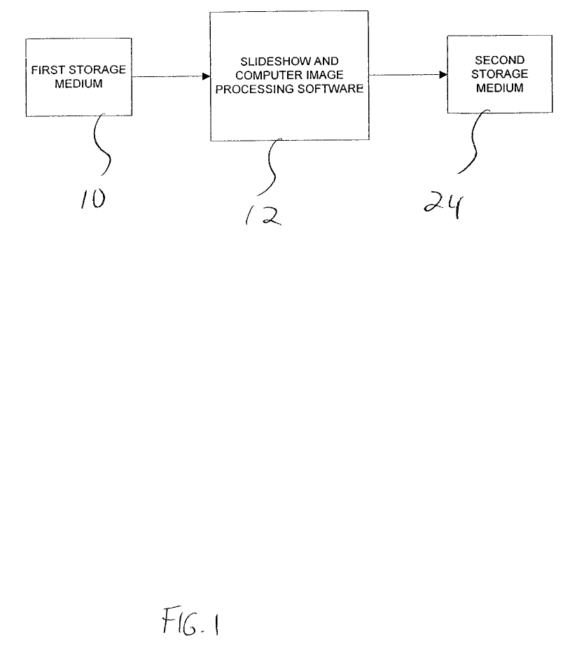

Referring now to FIG. 1, there is shown a block diagram in accordance with a preferred embodiment of the present invention. A first storage medium 10 contains digital image data in the form of image files, usually being representative of a plurality of still pictures. Typically, the first storage medium 10 includes a memory card from a digital camera or scanned digital images of analog photos of film. Another type of first storage medium 10 includes a hard disk from an analog film scanner or even a hard disk in a digital video cassette recorder.

In most digital cameras this memory card is conveniently removed and interfaced with a personal computer for viewing still photos on a personal computer monitor. The memory card is easily reinstalled into the camera for further use. Memory cards and digital cameras are well known to one skilled in the art. It is known in the art for the computer to read, store, display and even e-mail image files.

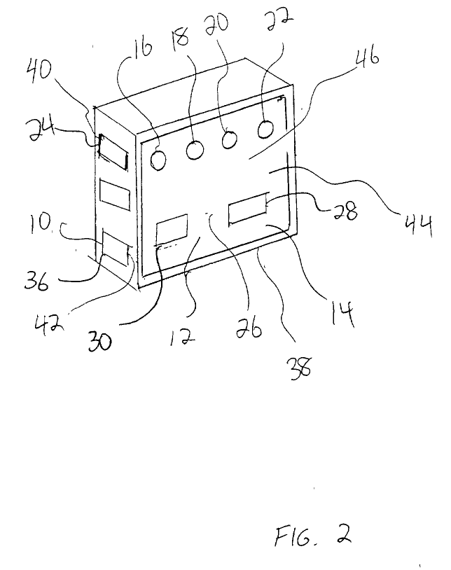

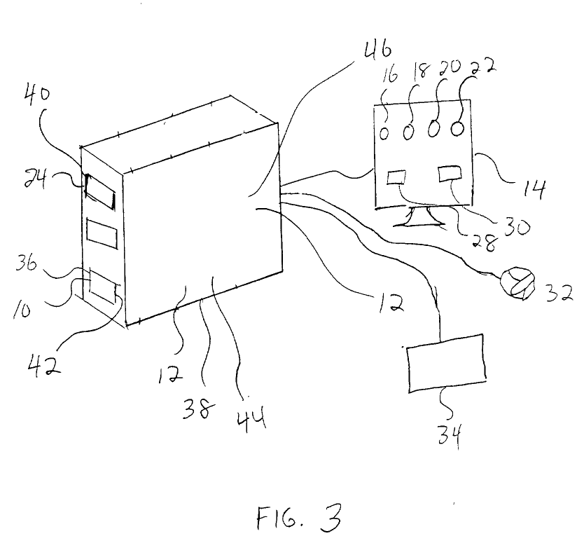

As shown in FIG. 1, the first storage medium 10 is interfaced with a computer software system 12. A display 14 which is linked to the computer software system 12, depicted in FIG. 2, includes an idle signal 16 which informs a user that the computer software system 12 is in an idle or standby mode. The display 14 and computer software system 12 can also be housed in separate units shown in FIG. 3.

A ready signal 18 alerts a user that the computer software system 12 is ready to proceed with a requested task. A busy signal 20 tells a user that the computer software system 12 is busy performing another task. Finally, a burning disk 22 signal confirms that the computer software system 12 is writing software to a second storage medium 24, typically a digital video disc (DVD).

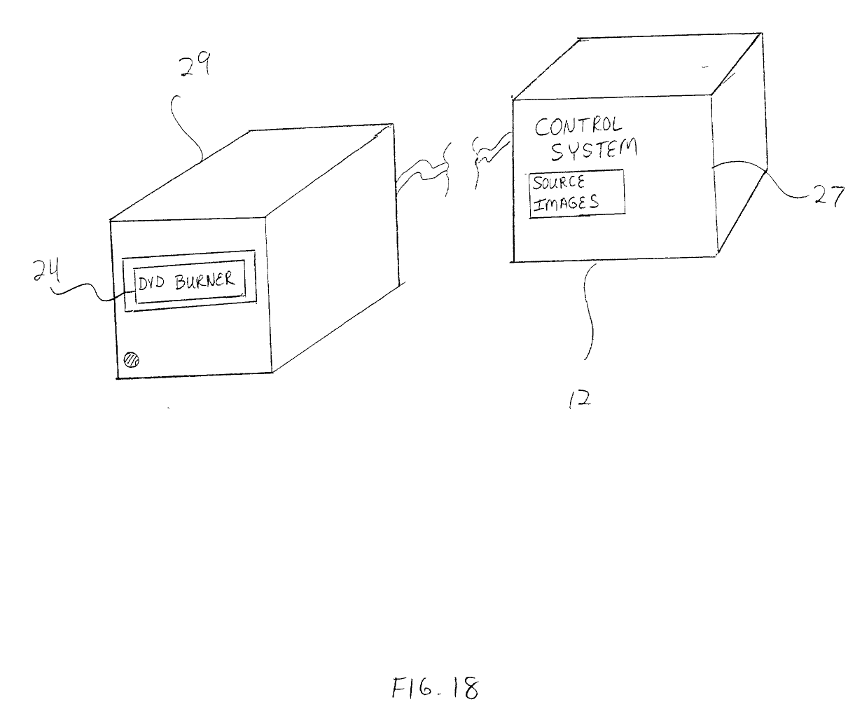

It is possible to automate all the processing steps from formatting first storage medium 10 to creating the second storage medium 24 of the computer system 12. FIG. 18 depicts this embodiment. In this embodiment, the computer system 12 is connected to a remote central computer by wired or wireless communication means. The remote computer sends commands to the computer system 12 to create the digital video discs (DVD). In response to the command, the computer system 12, reads the digital image files from the remote computer and creates the digital video disc (DVD) following the steps described herein.

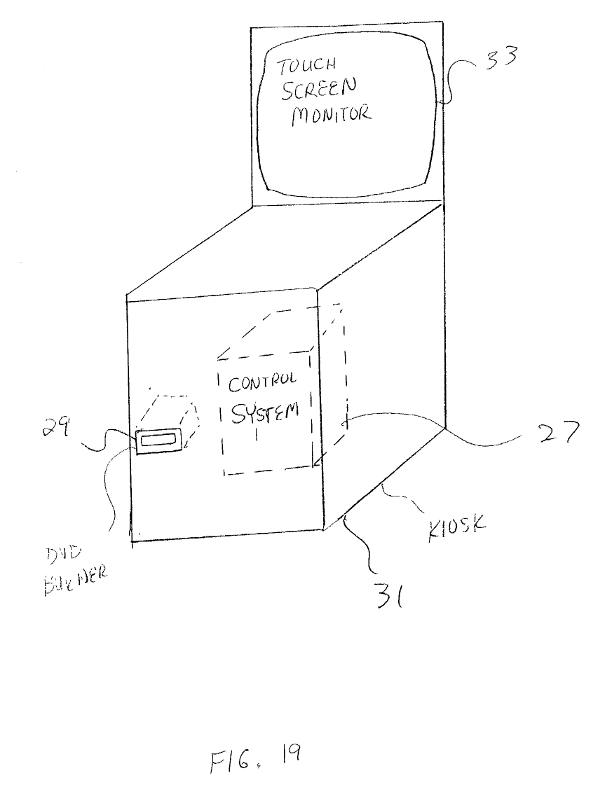

Looking at FIG. 19 and another embodiment, the control system 27 and DVD burner 29 are embedded in a kiosk 31. A kiosk touch screen monitor 33 gives the user interactive control of formatting the files to the second storage medium 24.

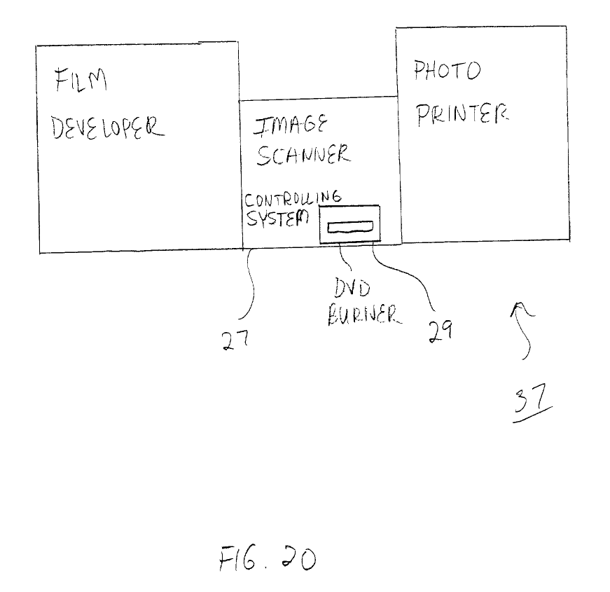

In still another application, and referring to FIG. 20, the control system 27 and DVD burner 29 are embedded in a photo finishing system 37.

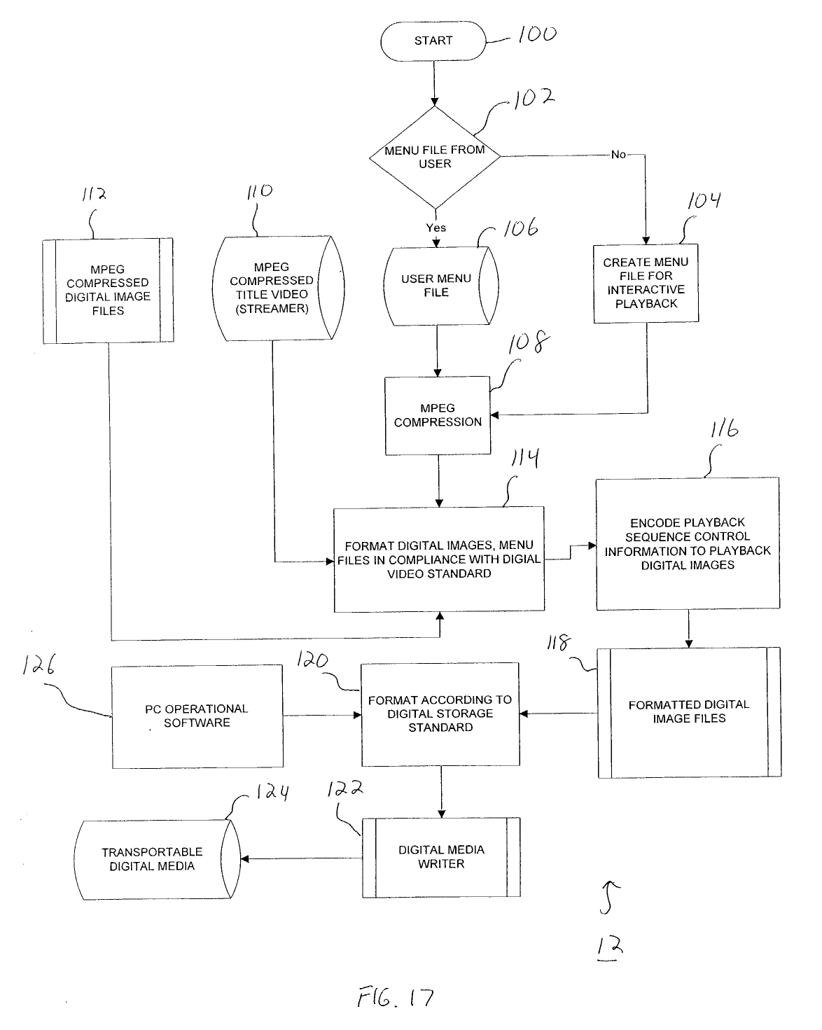

Referring now to FIG. 17, the computer system 12 functions step wise to create a transportable or second storage medium 24 in accordance with the present invention. The computer system 12 determines whether the user needs a menu file, step 102. If needed the computer system 12 creates a menu file for interactive playback, step 104. Otherwise, the user menu file is utilized, step 106. Next, the computer system 12 proceeds to MPEG compression to compress the menu files, step 108. The MPEG compressed menu file (step 108), the MPEG compressed title video files (step 110) and the MPEG compressed digital image files (step 112) are formatted to digital video standard, step 114.

The computer system 12 encodes playback sequence control information for playback of digital images, step 116. PC operational software is directly installed to the second storage medium, step 126. Next, the computer system 12 formats the digital image files according to a digital storage standard, steps 118 and 120. Now, the digital media writer writes the formatted digital image files to the transportable storage medium, steps 122 and 124.

There are many other types of storage devices that are applicable as the second storage medium 24. Some examples include a compact disk, a hard disk of an electronics device such as a personal computer, a digital video cassette recorder and other playback devices.

Referring to FIG. 3, the display 14 includes an interactive touch screen monitor 26 having a create input 28 and a cancel input 30. Once the create input 28 is selected, the interactive touch screen 26 may include additional inputs which allows the user to sequence and group the image files or the computer software system 12 may completely process the image files with no further input from the user. As shown in FIG. 3, a mouse 32 and keypad 34 can also be used to sequence, group and even manipulate image files. Other user interface buttons and status signals are also possible.

In use, a user interfaces the first storage medium 10 with the computer software system 12, typically by inserting the first storage medium 10 into a multi-format memory reader slot 36 that is disposed in a central processing unit housing 38. The user also interfaces the second storage medium 24 with the computer software system 12, typically by inserting a digital video disk into a DVD slot 40 that is disposed in the CPU housing 38.

Digital scanning software 42 scans the digital image files that are on the first storage medium 10. The digital scanning software 42 successfully scans image files in different types of formats. For example, Conica, Kodak, Mitsubishi and many other digital image technology companies use different formats to store digital image files onto digital image memory cards. JPEG, GIFF, TIFF and BMP are industry standards or widely known formats.

After scanning the image files, personal computer formatting software 12 formats the image files to personal computer image format. The computer software system 12 includes a menu file that permits the user to group the formatted image files into any desired playback sequence. Grouping of digital images can also be performed automatically by the computer. Once the image files are finally grouped according to the users choice, these grouped image files formatted for personal computers are then transferred to the second storage medium 24 using a digital media writer 58. The digital media writer may be physically disposed internal or external to the CPU housing 38.

The scanned image digital data is also formatted to a video standard format that is recognized by a selected video standard. The computer software system 12 includes a memory 46 for storing the digital image files and software that includes subroutines containing various video standards. Some video standards include (Digital VHS, DVD-Video, DVD-Photo, DVD-Multi, DVD, Internet Streaming Media and compressed digital video standards such as MPEG-1, MPEG-2 and JPEG). The video standards for DVD (read only disc) may be found in the following documents available by license from a DVD Logo and Licensing Corporation (managed by Toshiba Corporation of Tokyo, Japan; DVD-ROM) (Part 1: Physical Specification, Part 2: File System Specification), DVD-Video (Part 3: Video Specifications), DVD-Audio (Part 4: Audio Specification); and the following contains the MPEG (Moving Picture Experts Group) Standard; MPEG-1 (System): Standard ISO/IEC 1172-1, MPEG-1 (Video): Standard ISO/IEC 11172-2, MPEG-1 (Audio): Standard ISO/IEC 11172-3, MPEG-2 (System): Standard ISO/IEC 13818-1, MPEG-2 (Video): Standard ISO/IEC 13818-1, MPEG-2 (Audio): Standard ISO/IEC 13818-3; AC-3 Standards: “Digital Audio Compression Standard,” Advanced Television System Committee, Washington.

The computer software system 12 offers the user an option of selecting a video standard through the interactive touch screen 26 or it may be a preselected video standard, such as DVD. It should be apparent to one skilled in the art that other selection apparatus can also be employed, such as point and click using a mouse.

The computer software system 12 gives the user further options such as grouping, sequencing and manipulating the digital files for controlling the playback sequence. All of these functions can also be performed automatically by the computer.

The video standard formatted files are now grouped and transferred to the second storage medium 24. The second storage medium 24 now contains software and digital image files that are formatted for viewing, manipulating and sending via e-mail through a personal computer. The second storage medium 24 also contains software and digital image files that are formatted to allow the digital images to be played on a standard playback device using any known video standard.

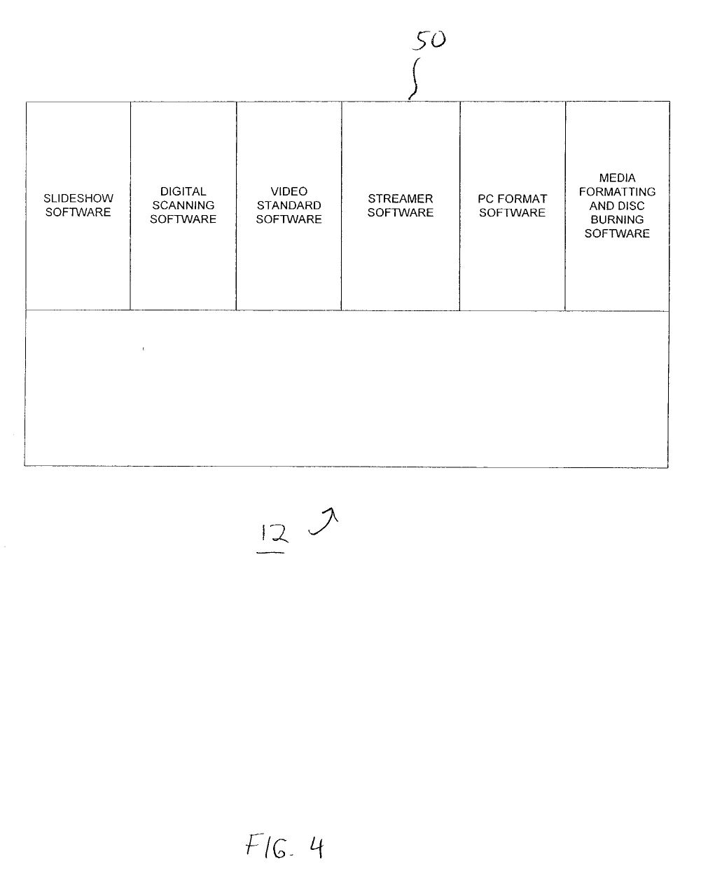

An additional feature of the computer software system 12 of the present invention includes a video streamer software program 50, shown in FIG. 4, that installs video streamer files to the second storage medium 24. Video streamer files are digital image files that are representative of a moving picture such as a an advertisement display, an acknowledgment, a moving scene or other type of moving picture.

One benefit of the video streamer is that advertisement can be sold by the owner or assignee of the computer software system 12, such that the advertisement appears when a user begins accessing his files on the second storage medium 24.

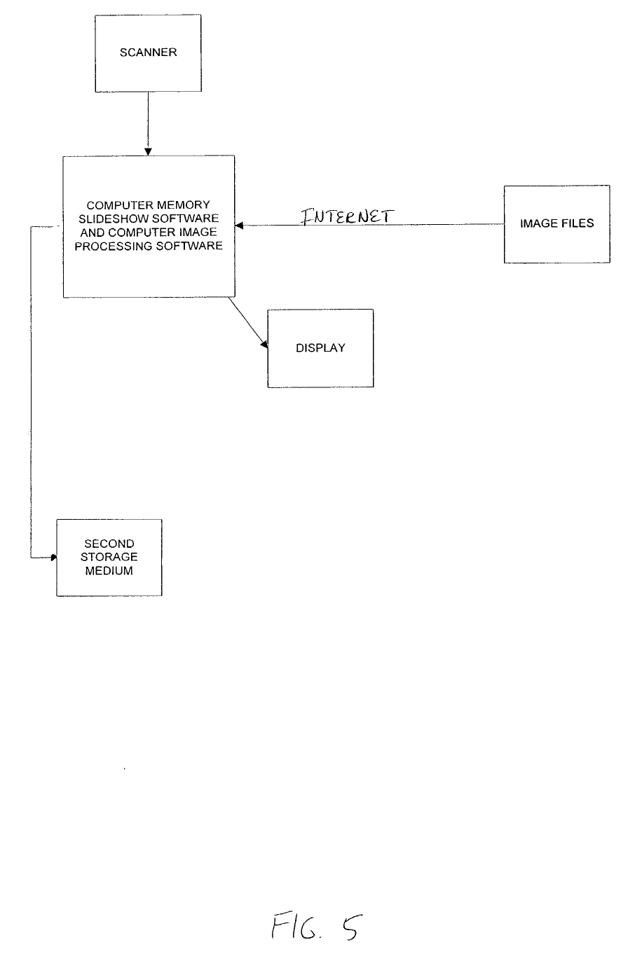

In another embodiment of the present invention shown in FIG. 5, the image files are transferred electronically, for example via the Internet, or some other form of networked connection to a central computer 54. A browser program serves as a graphical interface and allows the user to view, sequence, group, format, manipulate and write the image files to the second storage medium 24 in both the personal computer and video formats as described above. The browser also allows the user to select and install one of a predetermined video streamers as also described above.

The computer software system 12 creates a menu file, if needed, for interactive playback of the images.

In playback mode, the user has the option of either interfacing the second storage medium 24 with a personal computer or with another playback device, such as a digital video disc player, that is interfaced with a display device, such as a television monitor.

When the user selects playback with a personal computer, the software on the second storage medium 24 includes operational and application files that gives the personal computer the ability to allow the user many options with respect to playback.

The computer monitor first displays the video streamer, that has been previously described, before displaying thumbnail sketches representative of a first batch of grouped images.

From here the user selects one of the thumbnail sketches for manipulation, moves to a second batch of grouped images, or selects a slideshow option. If the user selects one of the thumbnail sketches, the selected sketch or image appears in a larger fashion on the computer monitor.

The user is now presented with a plethora of options for manipulating the selected image. These options are all known to one having skill in the art and some of these options include e-mailing the selected image, rotating the selected image, zooming in and out on the selected image and many other known options.

The user has the options of selecting for manipulation any of the thumbnail sketches at any time. When the user selects the slideshow presentation on his personal computer, the personal computer displays the images one at a time on the computer monitor. The displayed images use the entire pixel space on the display.

During slideshow presentation, the user has the option of moving forward or backward through the sequence of images or keeping the displayed image on the computer display. The displayed image does not change unless instructed to change by the user. The user has control of the slideshow playback sequence.

When the user chooses to interface the second storage medium 24 with a playback device such as a digital video disc player, that is interfaced with a standard television monitor the video streamer is displayed on the television. Following the video streamer, the slideshow presentation having the above described slideshow capabilities now appears on the television monitor. The user controls the playback sequence through the digital video disc player remote control.

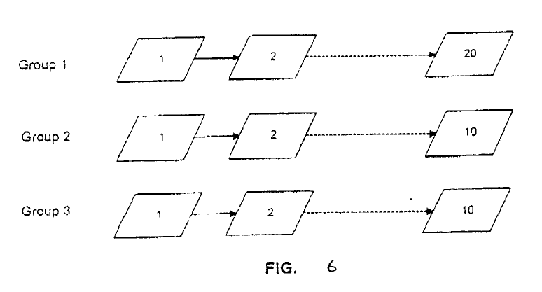

Turning back to processing the digital files to the second storage medium 24, and with reference to one example of a playback control sequence of digital images as depicted in FIG. 6, sequences of digital files are selected and placed in groups one, two and three. Group one is illustrated as containing a total of twenty images, while groups two and three each contain ten images. The images are grouped in any desired manner.

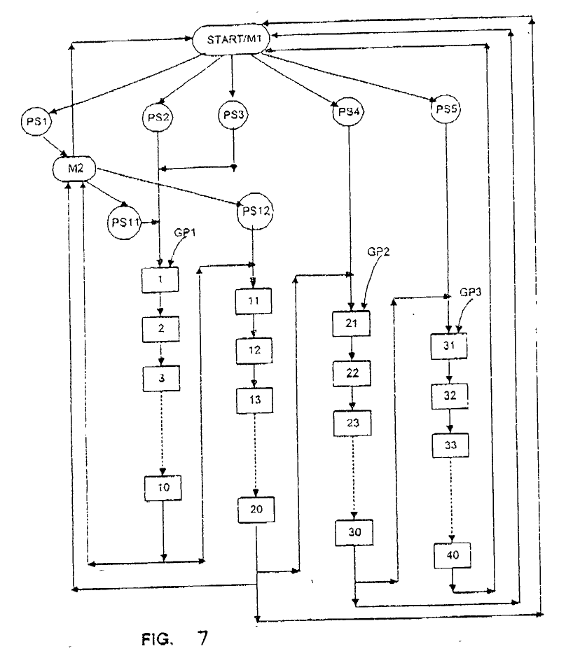

With reference to the example depicted in FIG. 7, a desired reproduction sequence of the digital image files of groups one, two and three are illustrated. Start/M1 is a root menu file that contains selection points PS1, PS2, PS3, PS4 and PS5. The images in group 1 are further divided into two playback sequences. Menu image M2 represents selection points PS11 and PS12 of playback sequences of digital images in group one. Each playback sequence comprises a linear sequence of digital image files and a return path to the selection points. The menu selection points can also be buttons or thumbnails of target images.

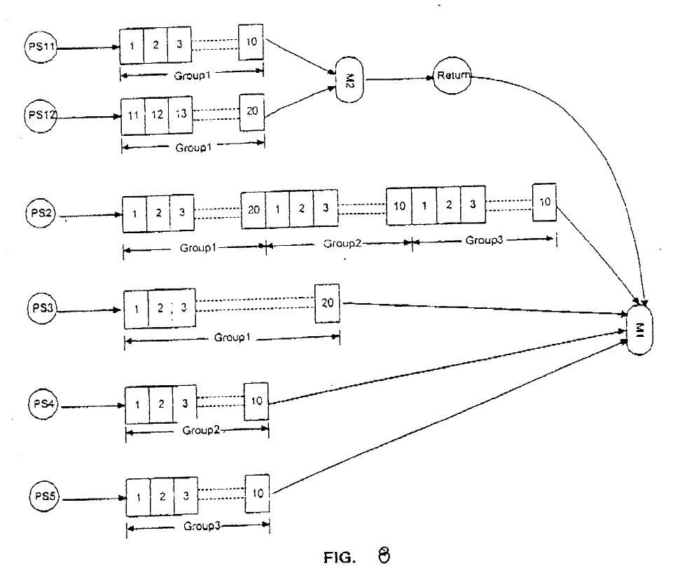

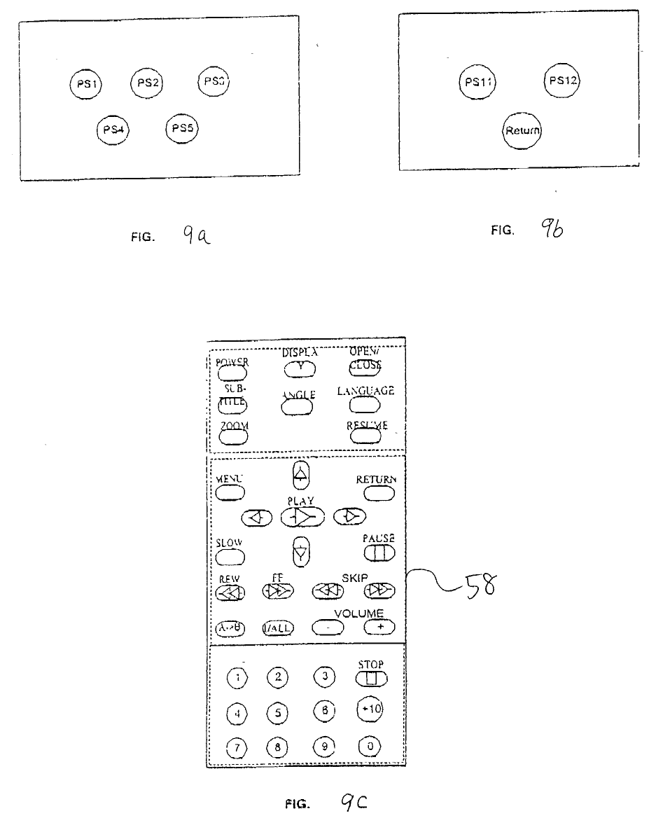

With reference to FIG. 8, all of the playback sequences of the digital image files shown in FIG. 7 are illustrated. FIGS. 9a and 9b illustrate example menu images that would appear on television and which contains the selection points of the playback sequences. A remote control unit 58, shown in FIG. 9c, is used to transmit commands to select selection points on the menu image. These menu images are stored on the second storage medium 24 along with the digital image files. The computer of the playback device creates the playback sequence in accordance with the video standard from the grouping of the digital image files.

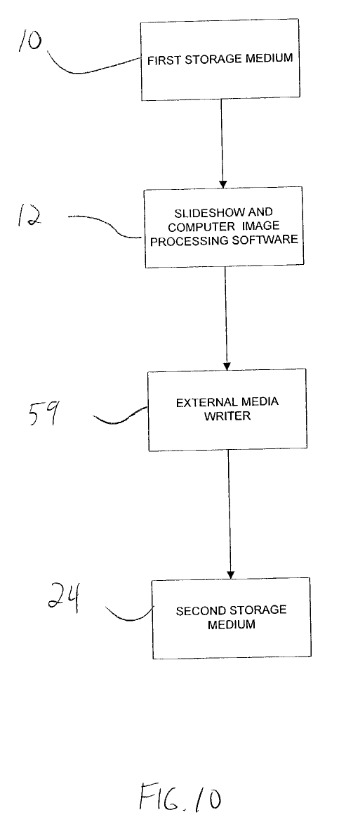

With reference to FIG. 10, the same system as that shown in FIG. 1 is reproduced with the exception that the computer software system 12 does not include a media writer incorporated therein. Instead, the external media writer 59 is interconnected between the computer software system 12 and the second storage medium 24.

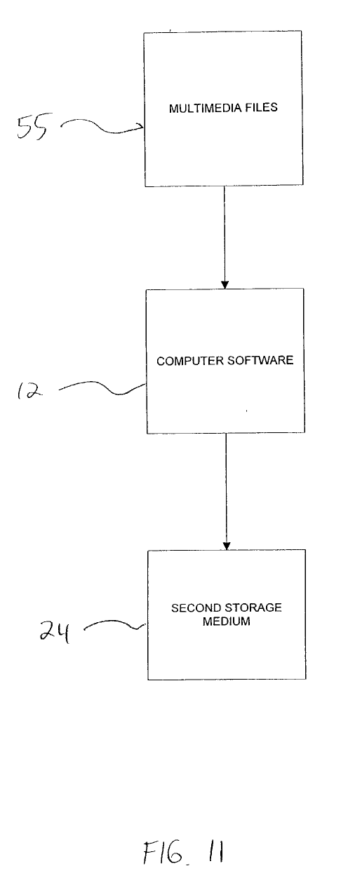

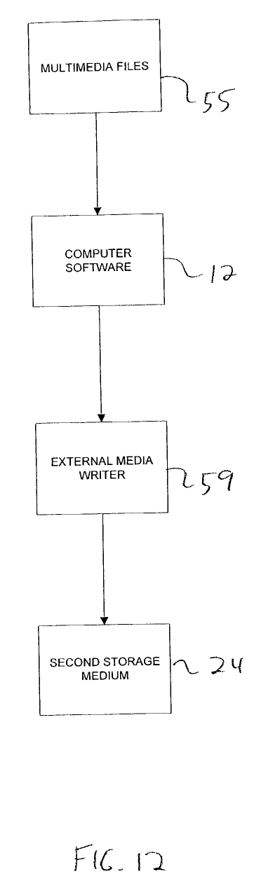

Before proceeding with a description of the embodiments illustrated in FIGS. 11 and 12, it is necessary to explain that the computer software system 12 is also capable of processing digital, audio and/or multimedia files 55 according to digital audio storage and playback standards. Audio standards include, for example, DVD-Audio, DVD-Multi, DVD, Internet Streaming Media standards, and compressed digital audio standards, such as AC-3, MPEG-1, MPEG-2 audio, MP3 etc. Uncompressed digital audio files are also supported.

Referring to FIG. 11, the computer software system 12 receives multimedia files 54 from the user. In the same manner as the computer software system 12 processes digital image files, it processes multimedia files 55 and writes the formatted files to the second storage medium 24. The computer software system 12 processes one or any combination of digital multimedia files according to corresponding standards to create the second storage medium 24.

Referring to FIG. 12, an analog to the embodiment shown in FIG. 11 is shown. Specifically, the computer software system 12 does not include an internal media writer, but instead needs to interconnect to the external media writer 59.

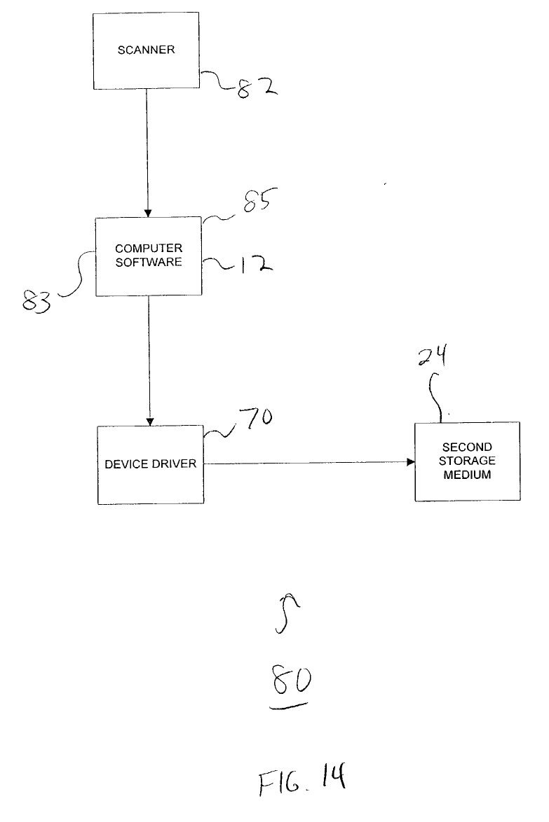

The present invention will now be described according to some preferred applications. In one application depicted in FIG. 14, a user brings a number analog photos or a roll of film 78 to an on-site unit 80. A scanner 82 scans the photos and sends digital image data files representative of the photos to a computer processing unit 83, having the computer software system 12, directly or via a scanning card. Memory 85 within the computer processing unit 83 stores the digital image data.

It should be noted that memory 85 is typically in the form of a hard disk and can be located anywhere in the application. Typically, it is common to locate the hard disk in either the scanner 82 or in the computer processing unit 83.

At this point, the user sequences and groups the image files as described above. The user has further options such as altering the digital image data files to remove red-eye, correcting other flaws or manipulating the images in other ways, such as rotating or zooming etc. Each of the functions can also be performed automatically by the computer. A media writer 70 now transfers the altered image files to the second storage medium 24 such as a digital video disc or compact disc. The media writer 70 can be either internal or external. The user can now interface the second storage medium 24 with either a personal computer or other playback device, such as a digital video player.

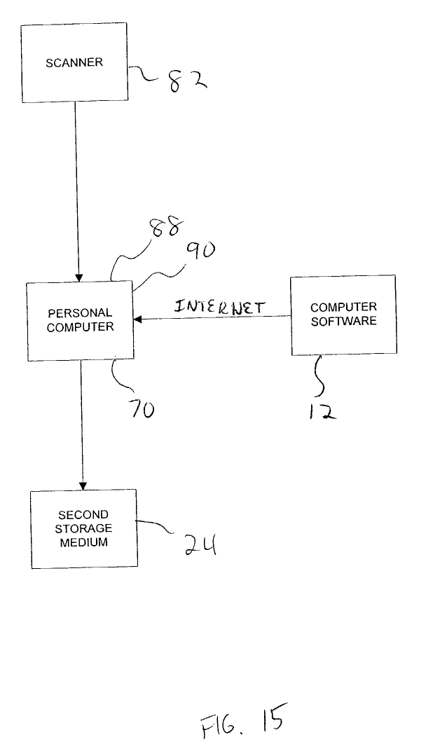

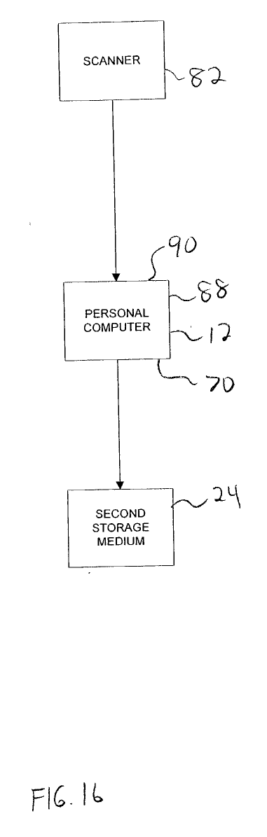

In another application shown in FIG. 15, a user having his own scanner 82 digitally scans his analog photos into digital image data files and stores them into memory 88 in his personal computer 90. From here the user accesses the computer software system 12 through the Internet or other network interface using a web browser. The user alters and stores the image files to the second storage medium as described above. In yet another application depicted in FIG. 16, the user actually installs the computer software system 12 into memory in his personal computer 90. This allows the user to process image files to the second storage medium 24 using his personal computer 90. The user can also have an internal or external media writer 70.

In yet another application, the user interfaces the first storage medium 10 such as a digital image memory card with either his own personal computer or an on-site unit and manipulates and stores the digital images to the second storage medium 24 as described above.

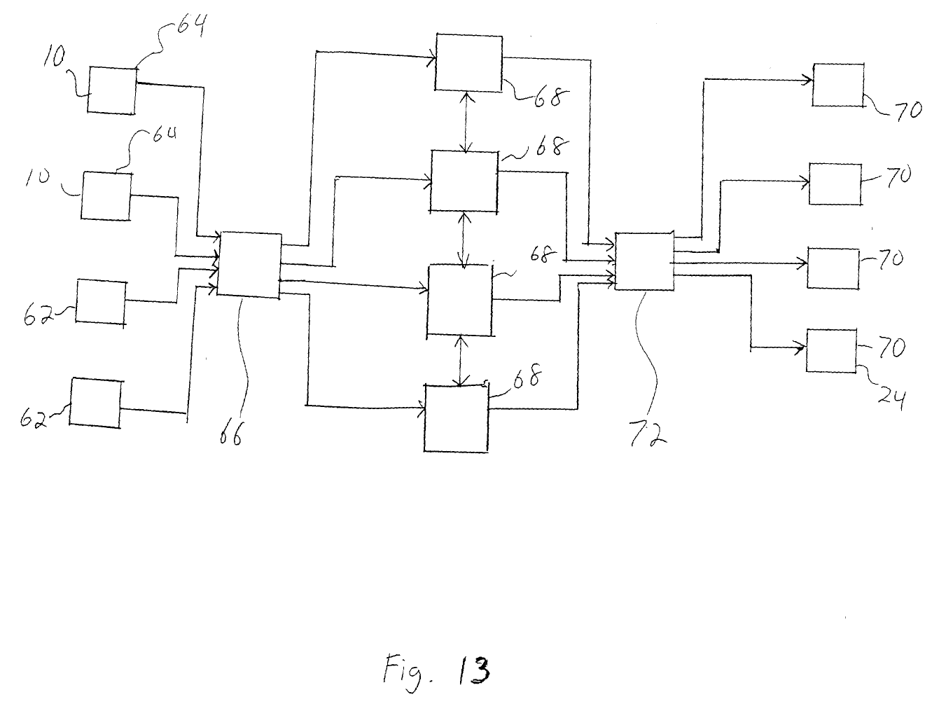

Referring now to FIG. 13, it is sometimes desirable to process image data to hundreds if not thousands of second storage mediums 24 daily in certain applications, such as for drop off facilities. In a drop off facility 92, a user can drop off a roll of film having analog photos either already processed photographs or a first storage medium 10 having digital image files. A scanner 62 digitally scans the analog photographs, while the first storage medium 10 is installed into one of a plurality of interfaces 64. The scanners 62 and interfaces 64 are connected to a plurality of processing units 68 via an input hub 66 such as an Ethernet hub, a universal serial bus or other hub wired or wireless interface.

The processing units 68 efficiently process many digital image files and transfer the image files to a plurality of device drivers 70 through an output hub 72, which is similar to the input hub 66. The device drivers 70 transfer the processed digital image files to a plurality of second storage mediums 24, so that many processed digital video discs can be created at once.

In the application depicted in FIG. 13, each of the processing units has access to any data files in the entire facility 92. Therefore, this system uses parallel processing to create many, for example, digital video disks simultaneously.

It should be noted that for all of the described applications, data can be transmitted via wireless or wired means.

Various changes and modifications, other than those described above in the preferred embodiment of the invention described herein will be apparent to those skilled in the art. While the invention has been described with respect to certain preferred embodiments and exemplifications, it is not intended to limit the scope of the invention thereby, but solely by the claims appended hereto.

What is claimed is:

1. An apparatus for converting digital image data files stored on a first storage medium to a second storage medium, wherein said digital image data files on said first storage medium includes digital image data of a plurality of images, said apparatus comprising:
computer software means;
a first interface means for interfacing said first storage medium to said computer software means;
a second interface means for interfacing said second storage medium to said computer software means;
wherein said computer software means comprises:
storage means for storing said digital image data files from said first storage medium;
a first formatting means for formatting said stored digital image data files to a personal computer format;
a second formatting means for formatting said stored digital image data files to at least one video standard format;
writing means for writing said formatted digital image data files to said second storage medium;
means for installing a first operational data onto said second storage medium, said first operational data being interactive with a personal computer operating system; and
means for installing a second operational data onto said second storage medium, said second operational data being interactive with a standard second storage medium player operating system.

2. The apparatus of claim 1, further including grouping means for grouping said digital image files into at least one subgroup.

3. The apparatus of claim 1, further including-manipulation means for altering at least one digital image file.

4. The apparatus of claim 1, further including sequencing means for storing said digital image file in a chosen sequence.

5. The apparatus of claim 1, further including display means for showing a status and control of said conversion.

6. The apparatus of claim 1, further including selection means for selecting at least one video standard format selected from the group consisting essentially of Digital VHS, DVD-Video, DVD photo, DVD-Multi, DVD, Internet Streaming Media and compressed digital video standards.

7. The apparatus of claim 1, wherein said second storage medium is selected from the group consisting essentially of a compact disc, a digital video disc (DVD) and a playback device internal memory.

8. The apparatus of claim 1, wherein said first storage medium includes a digital scanner capable of digitally scanning at least one still photograph.

9. The apparatus of claim 1, wherein said first storage medium is selected from the group consisting essentially of a memory card from a digital camera, a digital scanner memory, a hard disc, memory in a personal computer and a remote memory.

10. The apparatus of claim 9, wherein said at least one video standard format includes DVD-photo and DVD-video and said at least one personal computer format includes DVD-ROM.

11. A digital video disc that can be interfaced with a personal computer and a video standard display, said digital video disc including:
digital image data files that are representative of at least one image;
first computer software files for processing said digital image data files into a format that is readable by a personal computer; and
second computer software files for processing said digital image data files into a video standard format that is readable by a standard digital video disc playback device which is interfaced with a video standard display.

12. The digital video disc of claim 11, wherein said first computer software files includes grouping means for grouping said digital image data files into at least one subgroup.

13. The digital video disc of claim 12, wherein said first computer software files includes first display means for displaying thumbnail images of said at least one subgroup onto a computer monitor.

14. The digital video disc of claim 13, wherein said first computer software files include selection means for selecting image data files of at least one thumbnail image from said at least one subgroup.

15. The digital video disc of claim 14, wherein said first computer software files includes second display means for displaying a full image representative of said selected image data file.

16. The digital video disc of claim 15, wherein said first computer software files includes manipulation means for manipulating said displayed full image.

17. The digital video disc of claim 16, wherein said first computer software files includes copying means for copying image data files from a group of image data files consisting essentially of said at least one thumbnail image, said at least one displayed full image and said at least one manipulated full image.

18. The digital video disc of claim 11, wherein said second computer software files includes grouping means for grouping said image files into at least one subgroup.

19. The digital video disc of claim 18, wherein said second computer software files includes selection means for selecting one of said at least one subgroups.

20. The digital video disc of claim 19, wherein said second computer software files includes display means for displaying a first image onto the video standard display, wherein said first image is from said selected subgroup.

21. The digital video disc of claim 20, wherein said second computer software files includes control means for controlling the playback timing and sequence of said displayed images.

22. The digital video disc of claim 11, further including preselected video streamer files.

23. A multiple processing system for processing and transferring a plurality of separate digital image files to a plurality of second storage mediums, said multiple processing system comprising:
a plurality of digital scanning means for creating the plurality of separate digital image files from a plurality of separate analog photos or film roll;
a plurality of memory devices for storing the plurality of separate digital image files;
parallel computer processing means for processing the stored plurality of separate digital image files; and
a plurality of digital media writers for transferring said processed plurality of separate digital image files onto said plurality of second storage mediums.

24. The processing system of claim 23, wherein said computer processing means further includes computer software means comprising:
a first formatting means for formatting said stored plurality of separate digital image data files to a personal computer format; and
a second formatting means for formatting said stored digital image data files to at least one video standard format.

25. The processing system of claim 23, wherein said plurality of digital scanning means includes a plurality of digital scanners each capable of scanning at least one still analog photograph or roll of analog film.

26. The processing system of claim 23, wherein said plurality of memory devices are disposed within a plurality of digital scanner housings.

27. The processing system of claim 23, wherein said plurality of memory devices are disposed within a plurality of computer processor housings.

28. The processing system of claim 23 wherein said plurality of digital media writers are disposed within a plurality of computer processor housings.

29. The processing system of claim 23 wherein said plurality of digital media writers are disposed within a plurality of external media writers, said external media writers being linked with said parallel computer processing means by wired or wireless means.
